(19) United States
(12) Patent Application Publication
(10) Pub. No.: US 2012/0034340 A1
(43) Pub. Date: Feb. 9, 2012

(54) FOOD COMPOSITION AND RELATED METHODS FOR FRIED GNOCCO

(76) Inventor: Massimiliano PATRONCINI, MILANO (IT)

(21) Appl. No.: 13/205,880

(22) Filed: Aug. 9, 2011

(30) Foreign Application Priority Data
Aug. 9, 2010 (IT) SP2010A000004

(51) Int. Cl. A21D 10/00; A21D 8/04; A23L 1/01; A21D 2/02

(52) U.S. Cl. 426/26; 426/549; 426/62; 426/551

(57) ABSTRACT

A food composition is described for fried gnocco comprising flour and optionally lard, wherein when the lard is present, the lard quantity is less than 2% of the flour quantity. Methods for preparing fried gnocco are also described. Fried gnocco obtained by frying the described food composition may be softer, more easily digested, more consistent/uniform and non-deformed in appearance, and/or easily prepared.

### CROSS REFERENCE TO RELATED APPLICATIONS

The present application claims priority to Italian patent application SP2010A000004, filed on Aug. 9, 2010, which is incorporated herein by reference in its entirety.

### FIELD

The present disclosure relates to a food composition and related methods. In particular, it relates to a food composition for fried gnocco and methods for preparing fried gnocco.

### BACKGROUND

In traditional Italian cuisine, especially in Emilia and surrounding areas, a type of food named “gnocco fritto” or “fried gnocco” is very popular.

The fried gnocco is commonly prepared by frying kneaded dough to obtain inflated soft loaves, the dough comprising flour, water, yeast, salt and lard.

The fried gnocco is normally eaten warm, directly after cooking, often together with charcuterie or cheeses, and is sometimes eaten as a meal. Traditionally, fried gnocco is prepared at home, although widespread popularity has led to restaurants offering meals based on fried gnocco. Traditional fried gnocco food compositions are not well-suited for restaurants. Qualities of fried gnocco which may be relevant for its commercial success include digestibility, appearance (i.e. consistency/uniformity and/or color), texture (i.e. softness), taste, and/or ease of preparation.

For example, traditional recipes, based upon lard, can be difficult for people to digest. Regarding appearance, fried gnocco inflates during the cooking process and its outer appearance can change over time, due primarily to deflation. Although deflation may not be a concern when eating at home, demanding clients would not like this to happen and traditional recipes have not considered this issue.

There are a few recipes which describe variations of traditional recipes; however, they do not address the above-mentions problems that may be relevant for commercial success of the fried gnocco.

Therefore, there remains a need to provide a food composition for fried gnocchi which has a consistent/uniform and non-deformed appearance, is digestible, soft, and easy to prepare, while importantly, maintaining a high quality taste.

### SUMMARY

According to a first aspect of the disclosure, a food composition for fried gnocco comprising flour and optionally lard, wherein when the lard is present, the lard quantity is less than 2% of the flour quantity, is described.

According to a second aspect, a food composition comprising: 3 kg flour type 0, 3 kg flour type 00, 2 L light beer, 280 g table salt, 400 mL oil and 200 mL milk or 300 mL oil and 300 mL milk, 100 g or 75 g brewer's yeast, and about 50 mL water is described.

According to a third aspect, a method for preparing fried gnocco, the method comprising: preparing a food composition comprising flour, lard, and at least one other ingredient selected from the group consisting of: oil, milk, beer, water, sparking water, yeast, salt, butter, baking powder, and sugar; wherein: the lard quantity is less than 2% of the flour quantity, the flour comprises at least two different types of flour, the ratio of a first flour to a second flour of the at least two different types of flour is about 1:1; and splitting the food composition into reduced portions of uniform size, and frying said reduced portions is described.

The details of one or more embodiments of the disclosure are set forth in the accompanying drawings and the description below. Other features, objects, and advantages will be apparent from the description and drawings, and from the claims.

### DETAILED DESCRIPTION

The term “exactly” as used herein, is defined to mean an amount with small variations in quantity. For example, the small variations may be up to a few grams or a few percent.

The term “about” as used herein, is defined to mean an amount with a variation which is larger than the variation of “exactly”. For example, the variation may be up to a few tens of grams or between 5-6%.

In some embodiments, the fried gnocco food composition comprises flour and lard, wherein a lard quantity may be less than 2% of a flour quantity or less than 1% of the flour quantity. In some embodiments the lard is not present.

In some embodiments, the fried gnocco food composition comprises at least two different types of flours, for example, a first flour and a second flour.

In some embodiments, the quantity of the first flour may be exactly the same as the quantity of the second flour. In some embodiments, the quantity of the first flour may be about the same as the quantity of the second flour.

In some embodiments, both flours are white flours; the first flour can be, for example, an all-purpose flour and the second flour can be, for example, a pastry flour.

It is believed that having two different types of flour in the fried gnocco food composition may make the food composition more compact, thus discouraging formation of surface bubbles that can lead both to an inconsistent/non-uniform and/or deformed surface appearance and to cooking irregularities which may be detrimental to the taste of the fried gnocco. While it can be observed that using two different types of flour in the fried gnocco food composition leads to a more consistent/uniform and/or non-deformed surface appearance compared to traditional fried gnocco food compositions, the underlying theoretical explanation for this result is not clear.

In some embodiments, the food composition may comprise beer. The beer may be a light beer, for example, a pilsner. The weight ratio between beer and flour may be between 1:2-1:4, about 1:3, or exactly 1:3.

In some embodiments, the food composition does not comprise added water other than water needed for diluting yeast.

In some embodiments, the food composition does comprise water and the water is present in a quantity less than 50%, 30%, or 10% of the beer quantity.

In some embodiments water can be introduced in a quantity which is less than 5% of the beer quantity, minding the effects of environmental sources of water such as humidity.

The term “water” as used herein is defined herein to mean water for example, from a tap or a bottle and is not meant to include water that is inherently present in other compositions such as milk and beer, for example, even if water is the main ingredient in said compositions.

In some embodiments, the food composition may comprise liquids which are different from beer, wherein the quantity of the liquids may be between 400 ml and 800 ml, between 500 ml and 700 ml, about 600 ml, or exactly 600 mL.

For example, the liquids may be oil and milk, wherein a ratio of oil to milk may be between 1:2-3:1, between 1:1-2:1, about 1:1, exactly 1:1, about 2:1, or exactly 2:1.

In some embodiments, the oil may be a seed oil.

In some embodiments the food composition may comprise a quantity of salt wherein the quantity of salt is lower than 5% of an overall quantity of flour. For example, the salt may be about 4.6% of the overall quantity of flour.

In some embodiments, the food composition comprises a reduced yeast quantity compared to traditional recipes. For example, the yeast quantity may be between 1% and 2% of the overall flour quantity, by weight. In some embodiments the quantity of yeast may be about 1.6% or exactly 1.6%. In warmer climates, the yeast quantity can be reduced by 25%.

The yeast may be dissolved in a quantity of water which may be half of the quantity of the yeast, by weight. The yeast may be brewer's yeast.

As known in the art, a scaling up or scaling down of quantities of ingredients of a food composition, even if the ratios between the ingredients are maintained, can lead to variable results. Thus in some embodiments, the quantity of the first flour is 3 kg. It should be noted, however, that other quantities may be used and that the invention is in no way limited to this quantity. It should also be noted that when a different quantity of the first flour is used for example, the quantities of the other ingredients should be scaled accordingly to maintain the ratios as described herein.

In some embodiments, the food composition comprises: 3 kg type 0 flour, 3 kg type 00 flour, 2 l light beer, 280 g fine salt, 400 ml oil, 200 ml milk, 100 g brewer's yeast, about 50 ml water.

In some embodiments, the food composition comprises: 3 kg type 0 flour, 3 kg type 00 flour, 2 l light beer, 280 g fine salt, 300 ml oil, 300 ml milk, 100 g brewer's yeast, about 50 ml water.

The method of rising of the food composition may be performed according to known methods and thus will not be described herein.

The food composition may be cooked by known cooking methods, including but not limited to, frying and baking. When the cooking method is frying, the cooking method comprises splitting the food compositions into reduced portions of uniform size, each split portion adapted to become an individual fried gnocco, dimensions of said portions being known in the art.

The following examples are provided by way of illustration of the disclosure and are not intended to be limiting.

### EXAMPLE 1

### Food Composition for Fried Gnocco

500 g flour,

180 ml water,

12 g brewer's yeast,

10 g salt,

70 g lard,

25 g sugar.

### EXAMPLE 2

### Food Composition for Fried Gnocco

500 g flour,

30 g butter,

125 ml water,

125 ml milk,

5 g baking powder,

salt.

### EXAMPLE 3

### Food Composition for Fried Gnocco

500 g flour,

30 g oil,

125 ml water,

125 ml milk,

5 g baking powder,

salt.

### EXAMPLE 4

### Food Composition for Fried Gnocco

300 g flour,

15 g brewer's yeast,

25 g lard,

67 ml milk,

100 ml water,

salt.

### EXAMPLE 5

### Food Composition for Fried Gnocco

250 g flour,

120 ml water,

15 g yeast,

45 g oil.

### EXAMPLE 6

### Food Composition for Fried Gnocco

250 g flour,

25 g lard,

12 g brewer's yeast,

12.5 g salt,

between 40-80 ml sparkling water.

### EXAMPLE 7

### Food Composition for Fried Gnocco

250 g flour,

25 g lard,

12 g brewer's yeast,

12.5 g salt,

between 40-80 ml beer.

### EXAMPLE 8

### Food Composition for Fried Gnocco

500 g flour,

30 g oil,

250 ml water,

5 g baking powder,

salt.

### EXAMPLE 9

### Food Composition for Fried Gnocco

500 g flour,

30 g butter,

250 ml water,

5 g baking powder,

salt

### EXAMPLE 10

### Food Composition for Fried Gnocco

500 g flour,

30 g oil,

250 ml milk,

5 g baking powder,

salt.

### EXAMPLE 11

### Food Composition for Fried Gnocco

500 g flour,

30 g butter,

250 ml milk,

5 g baking powder,

salt.

### EXAMPLE 12

### Food Composition for Fried Gnocco

250 g flour,

25 g lard,

12 g yeast,

2.5 g salt,

sparkling water to taste.

### EXAMPLE 13

### Food Composition for Fried Gnocco

1 Kg flour,

100 ml oil,

between 3-4 g yeast for cakes,

5 g salt,

milk to taste.

### EXAMPLE 14

### Food Composition for Fried Gnocco

500 g flour,

between 10-15 g lard,

100 ml milk,

200 ml water,

5 g sugar,

5 g salt.

### EXAMPLE 15

### Food Composition for Fried Gnocco

250 g flour,

20 g brewer's yeast,

120 ml beer,

salt.

The examples set forth above are provided to give those of ordinary skill in the art a complete disclosure and description of how to make and use the embodiments of the food composition for fried gnocco of the disclosure, and are not intended to limit the scope of what the inventor regards as his disclosure. Modifications of the above-described modes for carrying out the disclosure can be used by persons of skill in the art, and are intended to be within the scope of the following claims.

Modifications of the above-described modes for carrying out the methods and systems herein disclosed that are obvious to persons of skill in the art are intended to be within the scope of the following claims. All patents and publications mentioned in the specification are indicative of the levels of skill of those skilled in the art to which the disclosure pertains. All references cited in this disclosure are incorporated by reference to the same extent as if each reference had been incorporated by reference in its entirety individually.

It is to be understood that the disclosure is not limited to particular methods or systems, which can, of course, vary. It is also to be understood that the terminology used herein is for the purpose of describing particular embodiments only, and is not intended to be limiting. As used in this specification and the appended claims, the singular forms “a”, “an”, and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

A number of embodiments of the disclosure have been described. Nevertheless, it will be understood that various modifications can be made without departing from the spirit and scope of the present disclosure. Accordingly, other embodiments are within the scope of the following claims.

What is claimed is:

1. A food composition for fried gnocco comprising flour and optionally lard, wherein when the lard is present, the lard quantity is less than 2% of the flour quantity.

2. The food composition according to claim 1 comprising at least two different types of flour.

3. The food composition according to claim 2 wherein the ratio of a first flour to a second flour of the at least two different types of flour is about 1:1.

4. The food composition according to claim 2 further comprising beer, wherein the ratio of beer to flour is between 1:2-1:4.

5. The food composition according claim 2 further comprising between 75 ml-125 ml of liquids other than beer or water per kg of flour.

6. The food composition according to claim 5, wherein:
the liquids are oil and milk, and
the liquids are in a ratio between 1:2-3:1.

7. The food composition according to claim 2 further comprising salt, wherein the salt quantity is less than 5% of the flour quantity and the salt is table salt.

8. The food composition according to claim 2 further comprising yeast wherein the quantity of yeast is between 1%-2% or of the overall flour quantity.

9. The food composition according to claim 3 further comprising beer, liquids other than beer, salt, and yeast,
wherein:
the ratio of beer to flour is between 1:2 and 1:4,
the liquids other than beer are oil and milk,
the total quantity of liquids other than beer is between 75 ml-125 ml,
the liquids other than beer are in a ratio between 1:2-3:1,
the salt quantity is less than 5% of the flour quantity, and
the quantity of yeast is between 1%-2% or of the overall flour quantity.

10. The food composition according to claim 2 further comprising at least one other ingredient selected from the group consisting of: oil, milk, beer, water, sparking water, yeast, salt, butter, baking powder, and sugar.

11. A food composition comprising:
3 kg flour type 0,
3 kg flour type 00,
2 L light beer,
280 g table salt,
400 mL oil and 200 mL milk or 300 mL oil and 300 mL milk,
100 g or 75 g brewer's yeast,
about 50 mL water.

12. Fried gnocco obtained by frying the food composition according to claim 1.

13. Fried gnocco obtained by frying the food composition according to claim 2.

14. Fried gnocco obtained by frying the food composition according to claim 3, the food composition further comprising beer, liquids other than beer, salt, and yeast,
wherein:
the ratio of beer to flour is between 1:2-1:4,
the liquids other than beer are oil and milk,
the total quantity of liquids other than beer is between 75 ml-125 ml,
the liquids other than beer are in a ratio between 1:2 and 3:1,
the salt quantity is less than 5% of the flour quantity, and
the quantity of yeast is between 1%-2% or of the overall flour quantity.

15. Fried gnocco obtained by frying a food composition according to claim 3, the food composition further comprising at least one other ingredient selected from the group consisting of: oil, milk, beer, water, sparking water, yeast, salt, butter, baking powder, and sugar.

16. A method for preparing fried gnocco, the method comprising splitting the food composition according to claim 1 into reduced portions of uniform size, and frying said reduced portions.

17. A method for preparing fried gnocco, the method comprising splitting the food composition according to claim 2 into reduced portions of uniform size, and frying said reduced portions.

18. A method for preparing fried gnocco, the method comprising:
preparing a food composition comprising flour, lard, and at least one other ingredient selected from the group consisting of: oil, milk, beer, water, sparking water, yeast, salt, butter, baking powder, and sugar;
wherein:
the lard quantity is less than 2% of the flour quantity,
the flour comprises at least two different types of flour,
the ratio of a first flour to a second flour of the at least two different types of flour is about 1:1; and
splitting the food composition into reduced portions of uniform size, and frying said reduced portions.

19. A method for preparing fried gnocco, the method comprising:
preparing a food composition according to claim 3, the food composition further comprising beer, liquids other than beer, salt, and yeast,
wherein:
the ratio of beer to flour is between 1:2 and 1:4,
the liquids other than beer are oil and milk,
the total quantity of liquids other than beer is between 75 ml-125 ml,
the liquids other than beer are in a ratio between 1:2 and 3:1,
the salt quantity is less than 5% of the flour quantity, and
the quantity of yeast is between 1%-2% or of the overall flour quantity; and
splitting the food composition into reduced portions of uniform size, and frying said reduced portions.
